(19) United States
(12) Patent Application Publication
(10) Pub. No.: US 2025/0297568 A1
(43) Pub. Date: Sep. 25, 2025

(54) METHOD FOR MONITORING AN EXHAUST GAS CATALYTIC CONVERTER OF AN INTERNAL COMBUSTION ENGINE

(71) Applicant: Rolls-Royce Solutions GmbH, Friedrichshafen (DE)

(72) Inventor: Johannes Bleckmann, Friedrichshafen (DE)

(73) Assignee: Rolls-Royce Solutions GmbH, Friedrichshafen (DE)

(21) Appl. No.: 19/231,743

(22) Filed: Jun. 9, 2025

Related U.S. Application Data
(63) Continuation of application No. PCT/EP2023/084619, filed on Dec. 6, 2023.

(30) Foreign Application Priority Data
Dec. 16, 2022 (DE) 10 2022 133 769.3
Dec. 6, 2023 (WO) PCTEP2023084619

(51) Int. Cl. F01N 11/00; G01M 15/10

(52) U.S. Cl. CPC F01N 11/007; G01M 15/102

(57) ABSTRACT

A method for monitoring an exhaust gas catalytic converter of an internal combustion engine includes: operating the engine at a first load point with a first metering rate; determining a first actual NH₃ value and a first actual catalytic converter efficiency; calculating a first observation value based on the first actual NH₃ value, the first actual catalytic converter efficiency, a first target NH₃ value, and a first target catalytic converter efficiency; operating the engine at the first load point with a second metering rate; determining a second actual NH₃ value and a second actual catalytic converter efficiency; calculating a second observation value based on the second actual NH₃ value, the second actual catalytic converter efficiency, a second target NH₃ value, and a second target catalytic converter efficiency; comparing first and second observation values; and evaluating the exhaust gas catalytic converter based on the comparing.

### CROSS REFERENCE TO RELATED APPLICATIONS

This is a continuation of PCT application no. PCT/EP2023/084619, entitled “METHOD FOR MONITORING AN EXHAUST-GAS CATALYTIC CONVERTER OF AN INTERNAL COMBUSTION ENGINE”, filed Dec. 6, 2023, which is incorporated herein by reference. PCT application no. PCT/EP2023/084619 claims priority to German patent application no. 10 2022 133 769.3, filed Dec. 16, 2022, which is incorporated herein by reference.

### BACKGROUND OF THE INVENTION

### 1. Field of the Invention

The present invention relates to internal combustion engines, and, more particularly, to exhaust gas catalytic converters.

### 2. Description of the Related Art

It is known that internal combustion engines with an exhaust gas catalytic converter, and in particular a reactant metering device, use an NH₃ sensor to monitor the exhaust gas catalytic converter and in particular to detect an NH₃ slip, especially in applications in which an NH₃ catalytic converter cannot be used, for example due to the use of fuels containing sulfur. The NH₃ sensor is fluidically arranged downstream from the exhaust gas catalytic converter and is designed to measure an NH₃ concentration in the exhaust gas. It is thereby possible to detect an NH₃ slip according to the regulatory requirements. However, one disadvantage is that such an NH₃ sensor must be regularly serviced. Another disadvantage is that such an NH₃ sensor is cross- sensitive to nitrogen oxide.

What is needed in the art is a method for monitoring an exhaust gas catalytic converter of an internal combustion engine and an internal combustion engine with a control device to carry out such a method, wherein the aforementioned disadvantages are at least partially rectified, optionally prevented.

### SUMMARY OF THE INVENTION

The present invention relates to a method for monitoring an exhaust gas catalytic converter of an internal combustion engine. In addition, the invention relates to an internal combustion engine with an exhaust gas catalytic converter, a reactant metering device and a control device which is designed to carry out a method for monitoring the catalytic converter of the internal combustion engine.

The present invention provides a method for monitoring an exhaust gas catalytic converter in an internal combustion engine having a reactant metering device, wherein the reactant metering device is arranged in particular upstream of the exhaust gas catalytic converter. The internal combustion engine is thereby operated at a first load point with a first metering rate of the reactant metering device. During operation with the first metering rate, a first actual NH₃ value and a first actual catalytic converter efficiency are determined. Moreover, a first observation value is calculated on the basis of the first actual NH₃ value, the first actual catalytic converter efficiency, a first target NH₃ value, and a first target catalytic converter efficiency. Subsequently, the internal combustion engine is operated at the first load point with a second metering rate of the reactant metering device. During operation with the second metering rate, a second actual NH₃ value and a second actual catalytic converter efficiency are determined. Moreover, a second observation value is calculated on the basis of the second actual NH₃ value, the second actual catalytic converter efficiency, a second target NH₃ value, and a second target catalytic converter efficiency. Subsequently, the first observation value and the second observation value are compared, and the exhaust gas catalytic converter is evaluated on the basis of the comparison. This allows the functionality of the exhaust gas catalytic converter to be advantageously determined in a simple manner. This makes it advantageously possible, in particular, to determine an NH₃ post-catalytic converter concentration, that is, a concentration of NH₃ that is present in the exhaust gas after passing through the exhaust gas catalytic converter, without using an NH₃ sensor. Moreover, it is possible to monitor adherence to the regulatory requirements in regard to the NH₃ post catalytic converter concentration and thus to NH₃ emissions, in particular without the use of an NH₃ sensor. It is also advantageously possible to adapt the control of the reactant metering device, in particular NH₃ metering to the exhaust gas catalytic converter, in particular to ageing of the exhaust gas catalytic converter.

In particular, a reactant, optionally a reducing agent, is introduced into the exhaust gas by way of a reactant metering device. In particular ammonia or an ammonia releasing reagent, in particular a urea-water-solution, is used as the reducing agent.

In particular, an increase in the metering rate of the reactant metering device leads to an increase of the actual NH₃ value. Moreover, a reduction in the metering rate of the reactant metering device leads to a reduction of the actual NH₃ value.

If there is no NH₃ slip on the exhaust gas catalytic converter, an increase in the

metering rate of the reactant metering device leads to an increase in the actual catalytic converter efficiency. It also applies that a reduction in the metering rate of the reactant metering device leads to a reduction of the actual catalytic converter efficiency, if there is no NH₃ slip at the exhaust gas catalytic converter. It can then be advantageously recognized that the NH₃ post-catalyst concentration is almost constant. In this case, the exhaust gas catalytic converter can advantageously be assessed as functioning effectively at the first load point with the first metering rate and the second metering rate.

If the exhaust gas catalytic converter operates at an NH₃ slip limit, a change in the metering rate leads to virtually no change or to only a slight change, particularly within predetermined limits, in the actual catalytic converter efficiency. This demonstrates that, advantageously, the NH₃ post catalytic converter concentration changes at least marginally.

If there is an NH₃ slip at the exhaust gas catalytic converter, an increase in the metering rate of the reactant metering device leads to a reduction of the actual catalytic converter efficiency. It further applies that a reduction in the metering rate of the reactant metering device leads to an increase of the actual catalytic converter efficiency, if there is an NH₃ slip at the exhaust gas catalytic converter. This advantageously provides recognition that the NH₃ post-catalytic converter concentration increases or decreases when the metering rate is increased or reduced. As a result, the exhaust gas catalytic converter can advantageously be assessed as functionally ineffective at the first load point with the first metering rate and the second metering rate.

The method is carried out in particular at a stationary first load point.

In one arrangement, the first metering rate and the second metering rate are respectively reduced by a predetermined reduction value if an NH₃ slip is detected, thereby obtaining a new first metering rate and a new second metering rate. Subsequently the method is again repeated at the first load point by using the new first metering rate and the new second metering rate. This iterative approach is repeated until an NH₃ slip limit is reached or until an NH₃ slip is no longer detected. Subsequently the first new metering rate or the second new metering rate is stored at the first load point, as a maximum metering rate of the exhaust gas catalytic converter.

The predetermined reduction value is in particular, at least 0.5% to at most 1%. In particular, the predetermined reduction value is optionally at least 0.6%, optionally at least 0.7%, optionally at least 0.8%, optionally at least 0.9%. Alternatively, or in addition, the predetermined reduction value is optionally at most 0.9%, optionally at most 0.8%, optionally at most 0.7%, optionally at most 0.6%.

In particular, the time interval between two successive executions of the method is at least 50 seconds to at most 200 seconds, optionally 100 seconds. In particular, the observation values are shifted between two successive implementations of the method in such a way that the first observation value is zero and an interval between the first observation value and the second observation value remains constant.

In the context of the current technical teaching, an actual NH₃ value is identified with formula symbol α_{target}. In particular, the first actual NH₃ value is identified with α_{actual}¹, and the second actual NH₃ value is identified with α_{actual}². Moreover, NH₃ value is identified with formula symbol α_{target}. In particular, the first target NH₃ value is identified with α_{target}¹, and the second target NH₃ value is identified with α_{Target}².

In the context of the current technical teaching, an actual catalytic converter efficiency is identified with formula symbol η_{actual}. In particular, the first actual catalytic converter efficiency is identified with η_{actual}¹, and the second actual catalytic converter efficiency is identified with η_{actual}². Moreover, a target catalytic converter efficiency is identified with formula symbol η_{target}. In particular, the first target catalytic converter efficiency is identified with η_{target}¹, and the second target NH₃ efficiency is identified with η_{target}².

In the context of the current technical teaching, an observation value is identified with formula symbol B. In particular, the first observation value is identified with B₁, and the second observation value is identified with B₂^{⋅}. The observation value is in particular a function of the actual NH₃ value, the target NH₃ value, the actual catalytic efficiency and the target catalytic efficiency, in particular B(α_{actual}, α_{target}, η_{actual}, η_{target}).

In one arrangement B₁=B(α_{actual}¹, α_{target}¹, η_{actual}¹, η_{target}¹) applies to the first observation value, and B₂=B(α_{actual}², α_{target}², η_{actual}², η_{target}²) applies to the second observation value.

In an alternative arrangement, the observation values are shifted in such a way that the first observation value is zero and an interval between the first observation value and the second observation value remains constant. Thereby B₁=B(α_{actual}¹, α_{target}¹, η_{actual}¹, η_{target}¹)−B(α_{actual}¹, α_{target}¹, η_{actual}¹, η_{target}¹) applies to the first observation value, and B₂=B(α_{actual}², α_{target}², η_{actual}², η_{target}²)−B(α_{actual}², α_{target}², η_{actual}², η_{target}²) applies to the second observation value.

In particular, target value NH₃, especially first target value NH₃ and second target value NH₃, and the target catalytic converter efficiency, especially the first target catalytic converter efficiency and the second target catalytic converter efficiency, are provided. Optionally, target NH₃ value, in particular first target NH₃ value and second target NH₃ value, and the target catalytic converter efficiency, in particular the first target catalytic converter efficiency and the second target catalytic converter efficiency, are stored in a control device of the internal combustion engine, in a characteristic map, containing in particular test bench data, in particular depending on the load point and/or depending on the exhaust gas temperature.

In one arrangement, the first target NH₃ value and the second target NH₃ value are identical. Alternatively, or in addition, the first target catalytic converter efficiency and the second target catalytic converter efficiency are identical.

In particular, observation value B is calculated by way of formula

$$B ( {α}_{actual} , {α}_{target} , {η}_{actual} , {η}_{target} ) = ( {η}_{actual} - {η}_{target} ) - ( {α}_{actual} - {α}_{target} )$$

A further development of the present invention provides that the actual NH₃ value, in particular first actual NH₃ value and second actual NH₃ value, is determined by way of a first NOₓ sensor that is arranged fluidically upstream of the exhaust gas catalytic converter and a control of the reactant metering device that is arranged fluidically between the first NOₓ sensor and the exhaust gas catalytic converter.

In particular, first NOₓ sensor is used to determine an NOₓ pre-catalytic converter concentration, especially in ppm units. Moreover, an NH₃ pre-catalytic converter concentration is determined by way of the first NOₓ sensor and the NH₃ metering device, in particular in units of ppm. In particular, the NH₃ pre-catalytic converter concentration is determined on the basis of the NOₓ pre-catalytic converter concentration, an NOₓ target concentration and a predetermined conversion factor. In particular, during operation at the first load point with the first metering rate, a first NOₓ pre-catalytic converter concentration and a first NH₃ pre-catalytic converter concentration are determined. In addition, a second NOₓ pre-catalytic converter concentration and a second NH₃ pre-catalytic converter concentration are determined during operation at the first load point with the second metering rate. Optionally, the actual NH₃ value is calculated as the quotient from the NH₃ pre-catalytic converter concentration and the NOₓ pre-catalytic converter concentration, wherein the first actual NH₃ value results as the quotient from the first NH₃ pre-catalytic concentration and the first NOₓ pre-catalytic converter concentration, and the second actual NH₃ value results as the quotient from the second NH₃ pre-catalyst concentration and the second NOₓ pre-catalytic converter concentration.

A further development of the present invention provides that the actual catalytic converter efficiency, in particular the first actual catalytic converter efficiency and the second actual catalytic converter efficiency are determined by way of the first NOₓ sensor and a second NOₓ senor which is fluidically arranged downstream from the exhaust gas catalytic converter.

The NOₓ pre-catalytic converter concentration is determined, in particular by way of the first NOₓ sensor, in particular in ppm units. Furthermore, a NOₓ post-catalytic converter concentration is determined, in particular in ppm units, by way of the second NOₓ sensor. In particular, during operation at the first load point with the first metering rate, the first NOₓ pre-catalytic converter concentration and a first NOₓ post-catalytic converter concentration are determined. In addition, the second NOₓ pre catalytic converter concentration and a second NOₓ post-catalytic converter concentration are determined during operation at the first load point with the second metering rate. The actual catalytic converter efficiency results from equation

$${η}_{target} = 1 - \frac{{σ}_{post}}{{σ}_{pre}} = \frac{{σ}_{pre} - {σ}_{post}}{{σ}_{pre}}$$

wherein the NOₓ post-catalytic concentration is identified with σₚₒₛₜ and the NOₓ pre-catalytic converter concentration is identified with σₚᵣₑ. Moreover, the following equations apply for the first actual catalytic converter efficiency and the second actual catalytic converter efficiency:

$${η}_{target}^{1} = 1 - \frac{{σ}_{post}^{1}}{{σ}_{pre}^{1}} = \frac{{σ}_{pre}^{1} - {σ}_{post}^{1}}{{σ}_{pre}^{1}}$$

$${η}_{target}^{2} = 1 - \frac{{σ}_{post}^{2}}{{σ}_{pre}^{2}} = \frac{{σ}_{pre}^{2} - {σ}_{post}^{2}}{{σ}_{pre}^{2}}$$

A further development of the present invention provides that the second metering rate of the reactant metering device is selected to be greater or less than the first metering rate.

In one arrangement, the second metering rate of the reactant metering device is selected to be at least 5% to at most 20% greater than the first metering rate of the reactant metering device.

In an additional arrangement, the second metering rate of the reactant metering device is selected to be at least 5% to at most 20% less than the first metering rate of the reactant metering device.

In one arrangement, the method is iteratively repeated until an NH₃ slip limit is reached or until an NH₃ slip is no longer detected. Additionally, the second metering rate is selected to be less than the first metering rate. As soon as the NH₃ slip limit is reached, or an NH₃ slip is no longer detected, the first new metering rate is optionally stored as a maximum metering rate of the exhaust gas catalytic converter at the first load point.

In an alternative arrangement, the method is repeated iteratively unit an NH₃ slip limit is reached or until an NH₃ slip is no longer detected. Additionally, the second metering rate is selected to be greater than the first metering rate. As soon as the NH₃ slip limit is reached, or an NH₃ slip is no longer detected, the second new metering rate is optionally stored as a maximum metering rate of the exhaust gas catalytic converter at the first load point.

The first metering rate is optionally selected to be greater than the second metering rate. Advantageously, this enables a more sensitive detection of the NH₃ slip and thus a more precise evaluation of the exhaust gas catalytic converter. Notably, the reaction balance in the catalytic converter shifts from oxidation reactions to selective reduction reactions if there is an NH₃ slip at the first metering rate. This increases in particular the conversion of NOₓ although the metered NH₃ pre-catalytic converter concentration decreases. In contrast, the conversion of NOₓ changes only slightly at most with an NH₃ slip, if the metered NH₃ pre-catalytic converter concentration is increased.

In particular, equation D₂=α·D₁, applies for first metering rate D₁ and second metering rate [symbol] , whereby a has a value of 0.80 to 0.95 or from 1.05 to 1.2. Thus, the value of the second metering rate is determined relative to the value of the first metering rate.

In particular, a difference between the first metering rate and the second metering rate is selected, depending on the exhaust gas temperature. At an exhaust gas temperature of less than 300° C., the second metering rate is optionally selected to be at most 20% greater than the first metering rate. Alternatively, or in addition, at an exhaust gas temperature of at least 300° C. to at most 400°° C., the second metering rate is selected to be at least 5% to at most 20% greater than the first metering rate. Alternatively, or in addition, at an exhaust gas temperature of more than 400° C., the second metering rate is selected to be at least 5% greater than the first metering rate. In one optional embodiment, the second metering rate is selected to be 20% greater than the first metering rate at an exhaust gas temperature of less than 300° C. Alternatively, or in addition, at an exhaust gas temperature of more than 400° C., the second metering rate is selected to be 5% greater than the first metering rate. Alternatively, or in addition, at an exhaust gas temperature of at least 300° C. to at most 400° C., a metering rate increase from the first metering rate to the second metering rate is interpolated between 20% and 5%, in particular linearly, depending on the exhaust gas temperature.

Alternatively, if exhaust gas temperature is lower than 300° C. the second metering rate is selected to be at most 20% less than the first metering rate. Alternatively, or in addition, if exhaust gas temperature is at least 300° C. to at most 400° C. the second metering rate is selected to be at least 5% to max. 20% less than the first metering rate. Alternatively, or in addition, at an exhaust gas temperature higher than 400° C., the second metering rate is selected at least 5% less than the first metering rate. In an optional arrangement, the second metering rate is selected 20% less than the first metering rate at an exhaust gas temperature of lower than 300° C. Alternatively or in addition, at an exhaust gas temperature of higher than 400° C., the second metering rate is selected 5% less than the first metering rate. Alternatively, or in addition, at an exhaust gas temperature of at least 300° C. to a maximum of 400° C., a metering rate reduction from the first metering rate to the second metering rate is interpolated, in particular linearly, between 20% and 5%, depending on the exhaust gas temperature.

A further development of the present invention provides that the first observation value and the second observation value are compared by calculating a difference from the first observation value and the second observation value. Thereby an NH₃ slip of the internal combustion engine, in particular the exhaust gas catalytic converter, is recognized if the absolute value of the difference is greater than a predetermined threshold value.

A further development of the present invention provides that-by way of a weighting function—a weighted first observation value is determined from the first observation value, and a weighted second observation value is determined from the first observation value. Furthermore, the weighted first observation value and the weighted second observation value are compared, wherein the exhaust gas catalytic converter is evaluated based on the comparison. Advantageously, it is possible by way of the weighting function to transform an observation value so that an evaluation of the exhaust gas catalytic converter is easier and more reliable based on the weighted observation values than in particular based on the non-weighted observation values.

In the context of the present technical teaching, a weighted observation value is identified with formula symbol B^{g}. In particular, the weighted first observation value is identified with B₁^{g} and the second weighted observation value is identified with B₂^{g}. In particular, the weighting function is identified with formular symbol G(⋅). In particular, B₁^{g}=G(B(α_{actual}¹, α_{target}¹, η_{actual}¹, η_{target}¹))·B(α_{actual}¹, α_{target}¹, η_{actual}¹, η_{target}¹) applies for weighted first observation value and B₂^{g}=G(B(α_{actual}², α_{target}², η_{actual}², η_{target}²)·B(α_{actual}², α_{target}², η_{actual}², η_{target} ²) for the second weighted observation value.

In particular, a polynomial is used as the weighting function, wherein formula G(B)=Σᵢαᵢ·Bⁱ applies for the weighting function. Parameters ai and the i-th powers of observation value B are used. In particular, a general parabola is used, which interpolates points {(−5;4), (−4; 3), (−3; 2), (−2; 1,5), (−1; 1), (0; 1) (1; 1), (2; 1,5), (3; 2), (4; 3), (5; 4)}.

Alternatively, a polynomial is used which interpolates points {(−6;2), (−2; 2), (−1; 1), (1; 1), (2; 2), (6; 2)}. In particular, the weighting function is used to assign a positive reinforcement factor to an observation value.

Weighting function G (B) is selected in particular so that a first interval between a first observation value B₁ and a second observation value B₂ is greater than a second interval between the associated weighted first observation value B₁^{g} and the associated weighted second observation value B₂^{g} if first observation value B₁ and second observation value B₂ are greater than an interval lower limit and less than an interval upper limit. In addition, weighting function G (B) is selected so that a first interval between a first observation value B₁ and a second observation value B₂ is less than a second interval between the associated weighted first observation value B₁^{g} and the associated weighted second observation value B₂^{g} if first observation value B₁ and second observation value B₂ are less than or equal to an interval lower limit and greater than or equal to an interval upper limit.

In particular, the weighted first observation value and the weighted second observation value are compared, by calculating the difference between the weighted first observation value and the weighted second observation value. Thereby an NH₃ slip of the internal combustion engine, in particular of the exhaust gas catalytic converter, is recognized if the absolute value of the difference is greater than a predetermined threshold value.

A further development of the present invention provides that during operation at the first load point with the second metering rate, a second observation value is determined respectively at a plurality of points in time. Subsequently, the plurality of second observation values is integrated, thereby obtaining an integrated second observation value.

The integrated second observation value is compared with the first observation value, whereby the exhaust gas catalytic converter is evaluated based on the comparison. In particular, one observation value, especially the second observation value, has a signal noise, so that it is advantageously possible by way of the integration to evaluate the exhaust gas catalytic converter independently of the signal noise.

In particular, the first observation value and the integrated second observation value are compared in that a difference between the first observation value and the integrated second observation value is calculated. An NH₃ slip of the internal combustion engine, in particular of the exhaust gas catalytic converter, is detected if the absolute value of the difference is greater than the predetermined threshold value.

A further development of the present invention provides that during operation at the first load point with the second metering rate, a weighted second observation value is determined at a plurality of points in time. Subsequently, the plurality of weighted second observation values is integrated, wherein an integrated weighted second observation value is obtained. The integrated weighted second observation value is compared with the weighted first observation value, whereby the exhaust gas catalytic converter is evaluated based on the comparison.

In particular, the weighted first observation value and the integrated weighted second observation value are compared by calculating the difference between the weighted first observation value and the integrated weighted second observation value. An NH₃ slip of the internal combustion engine, in particular the exhaust gas catalytic converter is thereby recognized if the absolute value of the difference is greater than the predetermined threshold value.

In the context of the present technical teaching, a period of time between adjustment of the second metering rate and the earliest determination of a first second observation value or a weighted first second observation value is referred to as the minimum time tₘᵢₙ. Moreover, in the context of the present technical teaching, a time interval between adjustment of the second metering rate and the last determination of an n-th second observation value or a weighted n-th second observation value is referred to as the maximum time tₘₐₓ.

In one arrangement the minimum time tmin is at most 1 second, optionally at most 2 seconds, optionally at most 5 seconds, optionally at most 10 seconds, optionally at most 15 seconds. Alternatively, or in addition, maximum time tₘₐₓ is at most 30 seconds, optionally at most 25 seconds, optionally at most 20 seconds, optionally at most 15 seconds. Alternatively, or in addition, a time interval between the minimum time tₘᵢₙ and the maximum time tₘₐₓ is at most 30 seconds, optionally at most 25 seconds, optionally at most 20 seconds, optionally at most 15 seconds.

The minimum time tₘᵢₙ and the maximum time tₘₐₓ are selected, in particular, depending on the exhaust gas temperature, whereby the time interval between minimum time tₘᵢₙ and maximum time tₘₐₓ is optionally constant regardless of the exhaust gas temperature. In particular, minimum time tₘᵢₙ and maximum time tₘₐₓ become shorter when the exhaust gas temperature increases.

A further development of the present invention provides that the method is carried out for a plurality of load points, wherein an evaluation of the internal combustion engine and in particular of the exhaust gas catalytic converter-depending on the respective load point—is stored in a load characteristic map. The exhaust gas catalytic converter can thereby be advantageously evaluated for the plurality of load points. Furthermore, a maximum metering rate of the reactant metering device can advantageously be determined on the basis of the evaluation for the plurality of load points.

In particular, the load characteristic map is spanned by an exhaust gas mass and the exhaust gas temperature and has a plurality of map tiles. In particular, a map tile is a cohesive area over a number of load points, each of which is defined in particular by an exhaust gas mass and an exhaust gas temperature.

In one arrangement, in addition to the evaluation of the internal combustion engine and in particular of the exhaust gas catalytic converter, a maximum metering rate of the reactant metering device is stored in the load characteristic map. This allows the reactant metering device to be optimally adjusted for the plurality of load points.

In particular, the maximum metering rate is stored for a load field tile in which the load point is located. In addition, the maximum metering rate is optionally stored in at least one additional load field tile, which is immediately adjacent to the load field file containing the load point.

A further development of the present invention provides that an evaluation-operating hour is stored in the load characteristic map in addition to the evaluation, wherein the evaluation-operating hour indicates the point in time of the evaluation. Advantageously, it is very easily possible by way of the evaluation-operating hour to decide if and when it is expedient to carry out the procedure again.

The evaluation-operating hour is stored, in particular for a load field tile in which the load point is located. In addition, the evaluation-operating hour is optionally stored in at least one additional load field tile that is located directly adjacent to the load field tile containing the load point.

One arrangement provides that during operation of the internal combustion engine at the first load point the evaluation-operating hour is compared with a current operating hour of the internal combustion engine, wherein the method for monitoring the exhaust gas catalytic converter is carried out on the basis of the comparison. In particular, the method for monitoring the exhaust gas catalytic converter is carried out, if a difference between the evaluation-operating hour and the current operating hour is greater than 24 hours, optionally greater than 100 hours.

The present invention also provides an internal combustion engine with an exhaust gas catalytic converter, a reactant metering device, a first NOₓ sensor, a second NOₓ sensor and a control device. First NOₓ sensor is herein arranged fluidically upstream from the exhaust gas catalytic converter. Moreover, the reactant metering device is arranged fluidically between first NOₓ sensor and the exhaust gas catalytic converter. The second NOₓ sensor is arranged fluidically downstream from the exhaust gas catalytic converter. In addition, the control device is designed to carry out an inventive method or a method according to one or a number of the previously described embodiments. Advantages occur in connection with the internal combustion engine, which were already explained in the context of the method for monitoring the exhaust gas catalytic converter.

The control device is optionally operatively connected with the reactant metering device, the first NOₓ sensor and the second NOₓ sensor, and is designed to control them respectively. Optionally, the target NH₃ value, in particular the first target NH₃ value and the second target NH₃ value, and the target catalytic converter efficiency, in particular the first target catalytic converter efficiency and the second target catalytic converter efficiency, are stored in a control device of the internal combustion engine, in a characteristic map containing in particular test bench data, in particular depending on the load point and/or depending on the exhaust gas temperature.

The reactant metering device is designed in particular to introduce a reactant, in particular a reducing agent, optionally ammonia or an ammonia releasing reagent, in particular a urea-water-solution into the exhaust gas.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of one design example of an internal combustion engine;

FIG. 2 is a flow chart of a first design example of the method for monitoring an exhaust gas catalytic converter; and

FIG. 3 a flow chart of a second design example of the method for monitoring an exhaust gas catalytic converter.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

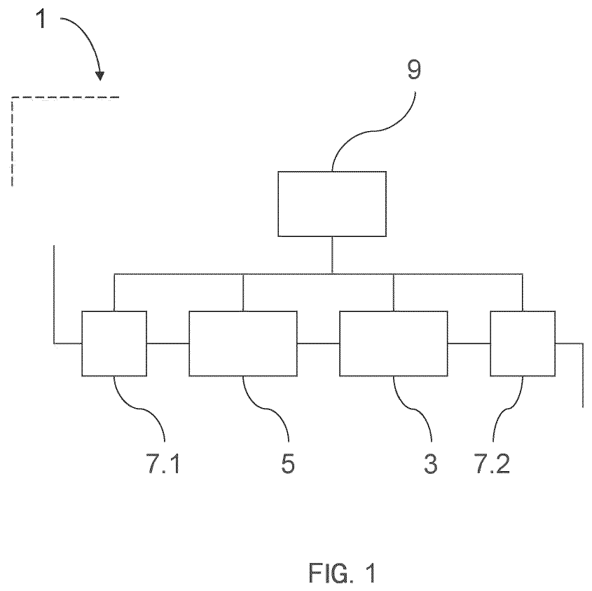

FIG. 1 is a schematic representation of a design example of an internal combustion engine 1. Internal combustion engine 1 includes an exhaust gas catalytic converter 3, a reactant metering device 5, a first NOₓ sensor 7.1, a second NOₓ sensor 7.2 and a control device 9.

First NOₓ sensor 7.1, reactant metering device 5, exhaust gas catalytic converter 3 and second NOₓ sensor 7.2 are fluidically connected with each other and with one combustion chamber of internal combustion engine 1, so that exhaust gas flows initially from the combustion chamber through first NOₓ sensor 7.1, then through reactant metering device 5, then through exhaust gas catalytic converter 3 and subsequently through second NOₓ sensor 7.2.

Reactant metering device 5 is designed to introduce a reactant, in particular a reducing agent, optionally ammonia or an ammonia releasing reagent, in particular, a urea-water-solution into the exhaust gas of internal combustion engine 1 at a predetermined metering rate 11, in particular a first metering rate 11.1 or a second metering rate 11.2. First NOₓ sensor 7.1 is designed in particular to determine a NOₓ pre-catalytic converter concentration, in particular in units of ppm. Moreover, first NOₓ sensor 7.1 and reactant metering device 5 are designed in particular, to determine an NH₃ pre-catalytic converter concentration, in particular, in ppm units.

In addition, second NOₓ sensor 7.2 is designed, in particular, to determine a NOₓ post-catalytic converter concentration, in particular, in ppm units.

Control device 9 is operatively connected with reactant metering device 5, with first NOₓ sensor 7.1 and with second NOₓ sensor 7.2, and is designed to control them respectively. Control device 9 is moreover designed to carry out a method for monitoring exhaust gas catalytic converter 3.

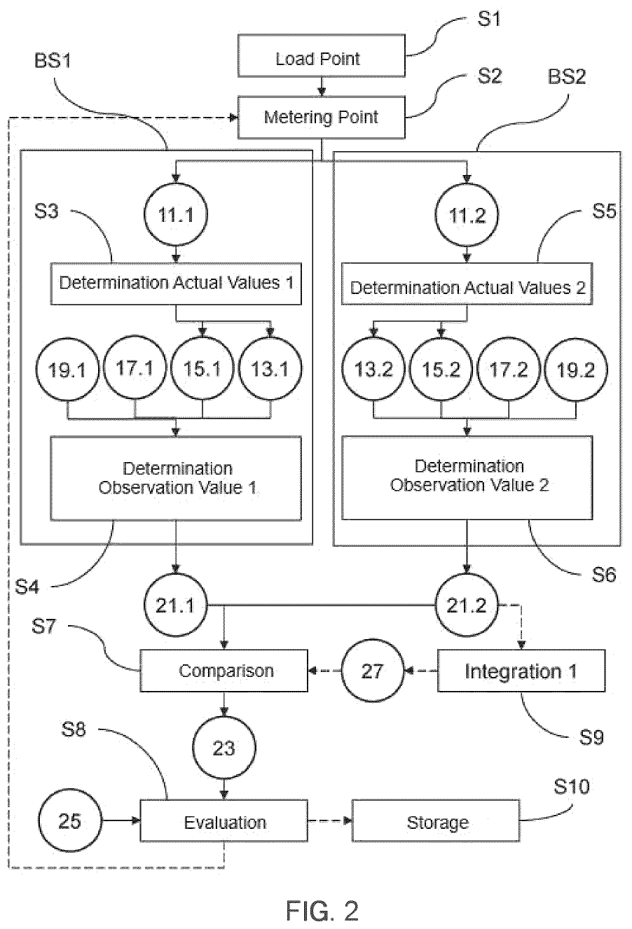

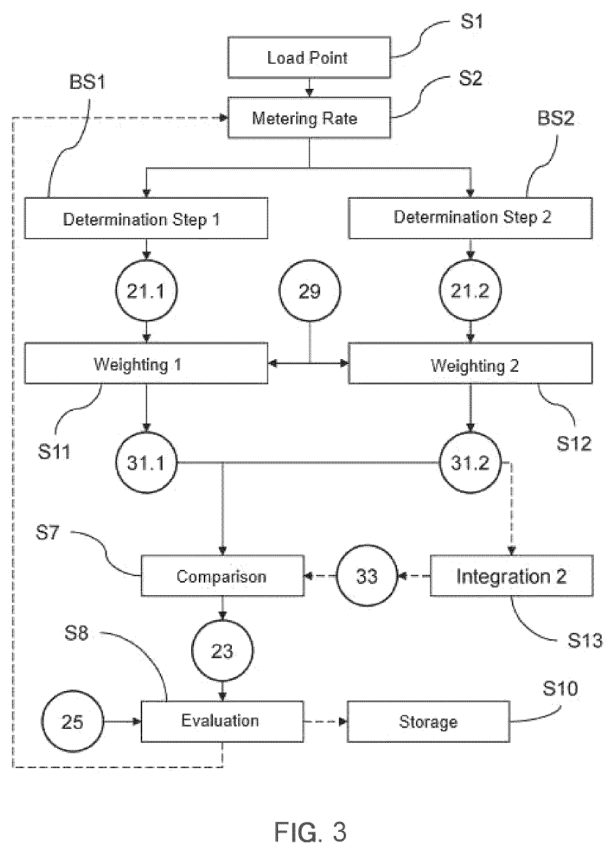

The method is explained in further detail in FIGS. 2 and 3.

FIG. 2 shows a flow chart of a first design example of a method for monitoring exhaust gas catalytic converter 3.

Identical and functionally identical elements are identified in all drawings with the same reference numbers so that reference can be made to a preceding description.

In a first step S1, a load point, in particular a first load point of internal combustion engine 1, is set. The load point is optionally a stationary load point.

In a second step S2, a first metering rate 11.1 of reactant metering device 5 and a second metering rate 11.2 of reactant metering device 5 are determined.

Optionally, second metering rate 11.2 of reactant metering device 5 is selected to be at least 5% to at most 20% greater than first metering rate 11.1 Alternatively, second metering rate 11.2 is selected to be at least 5% to at most 20% less than first metering rate 11.1.

In a third step S3, internal combustion engine 1 is operated at the first load point with first metering rate 11.1 At the same time, a first actual NH₃ value 13.1 and a first actual catalytic converter efficiency 15.1 are determined.

In a fourth step S4, a first observation value 21.1 is calculated on the basis of first actual NH₃ value, first actual catalytic converter efficiency 15.1, a first target NH₃ value and a first target catalytic converter efficiency 19.1. This provides, in particular, first target NH₃ value 17.1 and first target catalytic converter efficiency 19.1. First target NH₃ value 17.1 and first target catalytic converter efficiency 19.1 are optionally stored in control device 9 of internal combustion engine 1, in a characteristic map, containing in particular test bench data, in particular depending on the load point and/or depending on the exhaust gas temperature.

In a fifth step S5, internal combustion engine 1 is operated at the first load point with second metering rate 11.2. At the same time a second actual NH₃ value 13.2 and a second actual catalytic converter efficiency 15.2 are determined.

First actual NH₃ value 13.1 and second actual NH₃ value 13.2 are optionally determined in third step S3 and fifth step S5 by way of first NOₓ 7.1 sensor that is arranged fluidically upstream of exhaust gas catalytic converter 3 and a control of reactant metering device 5 that is arranged fluidically between first NOₓ sensor 7.1 and exhaust gas catalytic converter 3. In particular, first NOₓ pre-catalytic converter concentration and first NH₃ pre-catalytic converter concentration are determined in third step S3, wherein first actual NH₃ value 13.1 results as a quotient from first NH₃ pre-catalytic converter concentration and first NOₓ pre-catalytic converter concentration. In addition, in fifth step S5, a second NOₓ pre-catalytic converter concentration and a second NH₃ pre-catalytic converter concentration are determined, wherein second actual NH₃ value 13.2 results as the quotient from second NH₃ pre-catalytic converter concentration and second NOₓ pre-catalytic converter concentration.

In third step S3 and fifth step S5, first actual catalytic converter efficiency 15.1 and second actual catalytic converter efficiency 15.2 are optionally determined by way of first NOₓ sensor 7.1 and second NOₓ senor 7.2 which is fluidically arranged downstream from the exhaust gas catalytic converter 3. In particular, first NOₓ pre-catalytic converter concentration and a first NOₓ post-catalytic converter concentration are determined in third step S3, wherein first actual catalytic converter efficiency 15.1 is calculated by way of equation

$${η}_{target}^{1} = 1 - \frac{{σ}_{post}^{1}}{{σ}_{pre}^{1}} = \frac{{σ}_{pre}^{1} - {σ}_{post}^{1}}{{σ}_{pre}^{1}}$$

wherein first NOₓ post-catalytic concentration is identified with of post and first NOₓ pre-catalytic converter concentration is identified with σₚᵣₑ¹. In addition, second NOₓ pre-catalytic converter concentration and a second NOₓ post-catalytic converter concentration are determined in fifth step S5, wherein second actual catalytic converter efficiency 15.2 is calculated by way of equation

$${η}_{target}^{2} = 1 - \frac{{σ}_{post}^{2}}{{σ}_{pre}^{2}} = \frac{{σ}_{pre}^{2} - {σ}_{post}^{2}}{{σ}_{pre}^{2}}$$

wherein second NOₓ post-catalytic concentration is identified with σₚₒₛₜ², and NOₓ pre-catalytic converter concentration is identified with σₚᵣₑ².

In a sixth step, S6 a second observation value 21.2 is calculated on the basis of second actual NH₃ value 13.2, second actual catalytic converter efficiency 15.2, second target NH₃ value 17.2, and second target catalytic converter efficiency 19.2. In particular, second target NH₃ value 17.2 and second target catalytic converter efficiency 19.2 are thereby provided. Optionally, second target NH₃ value 17.2 and second target catalytic converter efficiency 19.2 are stored in control device 9 of internal combustion engine 1, in a characteristic map, containing in particular test bench data, in particular depending on the load point and/or depending on the exhaust gas temperature.

In particular, first target NH₃ value 17.1 and second target NH₃ value 17.2 are identical. Alternatively, or in addition, first target catalytic converter efficiency 19.1 and second target catalytic converter efficiency 19.2 are identical.

In particular, steps S3 and S4 are combined in a first determination step BS1 to determine the observation value 21.1. In addition, steps S5 and S6 are combined in a second determination step BS2 to determine second observation value 21.2.

In a seventh step S7, first observation value 21.1 and second observation value 21.2 are compared, resulting in comparison 23. First observation value 21.1 and second observation value 21.2 are optionally compared by calculating a difference between first observation value 21.1 and second observation value 21.2.

In eighth step S8, exhaust gas catalytic converter 3 is evaluated on the basis of comparison 23. Optionally, the difference is compared with a predetermined threshold value 25, wherein an NH₃ slip of internal combustion engine 1, in particular of exhaust gas catalytic converter 3, is recognized if the absolute value of the difference is greater than a predetermined threshold value 25.

Optionally, second determination step BS2 is carried out repeatedly, wherein a second observation value 21.2 is determined respectively for a plurality of points in time. Subsequently, the plurality of second observation values 21.2 is integrated at an optional ninth step S9, thereby obtaining an integrated second observation value 27. Integrated second observation value 27 is then compared in seventh step S7 with first observation value 21.1, wherein—on the basis of comparison 23—exhaust gas catalytic converter 3 is evaluated. In particular, first observation value 21.1 and integrated second observation value 27 are compared, in that a difference between first observation value 21.1 and integrated second observation value 27 is calculated. Thereby an NH₃ slip of internal combustion engine 1, in particular of exhaust gas catalytic converter 3, is recognized if the absolute value of the difference is greater than predetermined threshold value 25.

If an NH₃ slip is detected in eighth step S8, the method is restarted in second step S2. First metering rate 11.1 and second metering rate 11.2 are thereby reduced respectively by a predetermined reduction value. Subsequently, steps S3 to S8, in particular steps S3 to S9, are repeated. This iterative process is optionally repeated until an NH₃ slip limit is reached in eighth step S8 or an NH₃ slip is no longer detected.

In particular, a time interval between two successive executions of steps S2 to S8, in particular of steps S2 to S9, is at least 50 seconds to at most 200 seconds, optionally 100 seconds.

In optional tenth step S10, the evaluation of internal combustion engine 1 and in particular of exhaust gas catalytic converter 3 is stored in a load characteristic map.

Steps S1 to S10 are optionally carried out for a plurality of load points, wherein the evaluation of internal combustion engine 1 and in particular of exhaust gas catalytic converter 3 is stored in the load characteristic map. Optionally, an evaluation operating hour is also stored in the load characteristic map, in addition to the evaluation, wherein the evaluation operating hour indicates the time of the evaluation.

FIG. 3 shows a flow chart of a second design example of the method for monitoring exhaust gas catalytic converter 3.

Analogous to FIG. 2, a load point, in particular a first load point of internal combustion engine 1, is set in first step S1. Moreover, also analogous to FIG. 2 a first metering rate 11.1 and a second metering rate 11.2 are determined in second step S2.

Thereafter, first determination step BS1 and second determination step BS2 are carried out according to FIG. 2, thus obtaining first observation value 21.1 and second observation value step 21.2.

In an eleventh step S11, first observation value 21.1 is weighted by way of a weighting function 29, whereby a weighted first observation value 31.1 is determined.

In a twelfth step S12, second observation value 21.2 is weighted by way of weighting function 29, whereby a second observation value 31.2 is determined.

In seventh step S7, weighted first observation value 31.1 and weighted second observation value 31.2 are compared, thereby receiving comparison 23. Weighted first observation value 31.1 and weighted second observation value 31.2 are compared, in that the difference from weighted first observation value 31.1 and weighted second observation value 31.2 is calculated.

Eighth step S8 and optional tenth step S10 are analogous to FIG. 2.

Optionally, second determination step BS2, analogous to FIG. 2, is carried out

repeatedly, wherein a second observation value 21.2 is determined respectively at a plurality of points in time. Moreover, each of the second observation values 21.2 are weighted in twelfth step S12, wherein a plurality of weighted second observation values 31.2 are obtained. Subsequently, in an optional thirteenth step S13, the plurality of weighted second observation values 31.2 are integrated, wherein an integrated weighted second observation value 33 is obtained. Integrated weighted second observation value 33 is then compared in seventh step S7 with first weighted observation value 31.1, wherein—on the basis of comparison 23—exhaust gas catalytic converter 3 is evaluated. In particular, weighted first observation value 31.1 and integrated weighted second observation value 33 are compared, in that a difference between weighted first observation value 31.1 and integrated weighted second observation value 33 is calculated. An NH₃ slip of internal combustion engine 1, in particular of exhaust gas catalytic converter 3 is thereby recognized if the absolute value of the difference is greater than predetermined threshold value 25.

If an NH₃ slip is detected in eighth step S8, the method is optionally restarted in second step S2. First metering rate 11.1 and second metering rate 11.2 are reduced respectively by a predetermined reduction value. Subsequently, steps S3 to S12, in particular steps S3 to S13, are again repeated. This iterative process is optionally repeated until an NH₃ slip limit is reached in eighth step S8 or an NH₃ slip is no longer detected.

In particular, a time interval between two successive executions of steps S2 to S12, in particular of steps S2 to S13, is at least 50 seconds to at most 200 seconds, optionally 100 seconds.

Steps S1 to S12, in particular steps S1 to S13, are optionally carried out for a plurality of load points, wherein the evaluation of internal combustion engine 1 and in particular of exhaust gas catalytic converter 3 is stored in the load characteristic map. Optionally, an evaluation operating hour is also stored in the load characteristic map, in addition to the evaluation.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for monitoring an exhaust gas catalytic converter of an internal combustion engine, the method comprising the steps of:
providing that the internal combustion engine includes a reactant metering device;
operating the internal combustion engine at a first load point with a first metering rate of the reactant metering device;
determining, during operation with the first metering rate, a first actual NH₃ value and a first actual catalytic converter efficiency;
calculating a first observation value based on the first actual NH₃ value, the first actual catalytic converter efficiency, a first target NH₃ value, and a first target catalytic converter efficiency;
operating the internal combustion engine at the first load point with a second metering rate of the reactant metering device;
determining, during operation with the second metering rate, a second actual NH₃ value and a second actual catalytic converter efficiency;
calculating a second observation value based on the second actual NH₃ value, the second actual catalytic converter efficiency, a second target NH₃ value, and a second target catalytic converter efficiency;
comparing a first observation value and a second observation value; and
evaluating the exhaust gas catalytic converter based on a comparison resulting at least in part from the step of comparing.

2. The method according to claim 1, wherein at least one of:
(a) an actual NH₃ value is determined by way of a first NOₓ sensor that is arranged fluidically upstream of the exhaust gas catalytic converter and a control of the reactant metering device that is arranged fluidically between the first NOₓ sensor and the exhaust gas catalytic converter; and
(b) an actual catalytic converter efficiency is determined by way of first NOₓ sensor and a second NOₓ senor which is fluidically arranged downstream the from exhaust gas catalytic converter.

3. The method according to claim 2, wherein at least one of:
(a) the actual NH₃ value is at least one of the first actual NH₃ value and the second actual NH₃ value; and
(b) the actual catalytic converter efficiency is at least one of the first actual catalytic converter efficiency and the second actual catalytic converter efficiency.

4. The method according to claim 1, wherein the second metering rate of the reactant metering device is selected to be at least 5% to at most 20% greater or less than the first metering rate.

5. The method according to claim 1, wherein the first observation value and the second observation value are compared by calculating a difference from the first observation value and the second observation value, and wherein an NH₃ slip of the internal combustion engine is recognized if the absolute value of the difference is greater than a predetermined threshold value.

6. The method according to claim 1, wherein, by way of a weighting function, a weighted first observation value is determined from the first observation value, and a weighted second observation value is determined from the first observation value, wherein the weighted first observation value and the weighted second observation value are compared, wherein the exhaust gas catalytic converter is evaluated based on the comparison.

7. The method according to claim 6, wherein at the first load point with the second metering rate, the weighted second observation value is determined respectively at a plurality of points in time, wherein a plurality of weighted second observation values is integrated, wherein an integrated weighted second observation value is obtained, wherein the integrated weighted second observation value is compared with the weighted first observation value, wherein the exhaust gas catalytic converter is evaluated based on the comparison.

8. The method according to claim 1, wherein at the first load point with the second metering rate, a second observation value is determined respectively at a plurality of points in time, wherein a plurality of second observation values are integrated thereby obtaining an integrated second observation value, wherein the integrated second observation value is compared with the first observation value, wherein the exhaust gas catalytic converter is evaluated based on the comparison.

9. The method according to claim 1, wherein the method is carried out for a plurality of load points, wherein an evaluation of the internal combustion engine is stored in a load characteristic map.

10. The method according to claim 9, wherein an evaluation-operating hour is stored in the load characteristic map in addition to the evaluation, wherein the evaluation-operating hour indicates a point in time of the evaluation.

11. An internal combustion engine, comprising:
an exhaust gas catalytic converter;
a reactant metering device;
a first NOₓ sensor;
a second NOₓ sensor; and
a control device, the first NOₓ sensor being arranged fluidically upstream from the exhaust gas catalytic converter, the reactant metering device being arranged fluidically between the first NOₓ sensor and the exhaust gas catalytic converter, the second NOₓ sensor being arranged fluidically downstream from the exhaust gas catalytic converter, the control device being configured for carrying out a method for monitoring an exhaust gas catalytic converter of an internal combustion engine, the method comprising the steps of:
providing that the internal combustion engine includes the reactant metering device;
operating the internal combustion engine at a first load point with a first metering rate of the reactant metering device;
determining, during operation with the first metering rate, a first actual NH₃ value and a first actual catalytic converter efficiency;
calculating a first observation value based on the first actual NH₃ value, the first actual catalytic converter efficiency, a first target NH₃ value, and a first target catalytic converter efficiency;
operating the internal combustion engine at the first load point with a second metering rate of the reactant metering device;
determining, during operation with the second metering rate, a second actual NH₃ value and a second actual catalytic converter efficiency;
calculating a second observation value based on the second actual NH₃ value, the second actual catalytic converter efficiency, a second target NH₃ value, and a second target catalytic converter efficiency;
comparing a first observation value and a second observation value; and
evaluating the exhaust gas catalytic converter based on a comparison resulting at least in part from the step of comparing.
